(19) United States
(12) Patent Application Publication
(10) Pub. No.: US 2014/0142761 A1
(43) Pub. Date: May 22, 2014

(54) BELT DRIVE APPARATUS

(71) Applicant: CANON KABUSHIKI KAISHA, Tokyo (JP)

(72) Inventors: Yuri Mori, Tokyo (JP); Shinji Yamamoto, Kawasaki-shi (JP)

(73) Assignee: CANON KABUSHIKI KAISHA, Tokyo (JP)

(21) Appl. No.: 14/085,619

(22) Filed: Nov. 20, 2013

(30) Foreign Application Priority Data
Nov. 22, 2012 (JP) 2012-256793

(51) Int. Cl. G05B 13/00

(52) U.S. Cl. CPC G05B 13/00
USPC 700/275

(57) ABSTRACT

A second storage unit stores an edge position of an endless belt detected by an edge sensor. A position fluctuation amount calculation unit compares the edge position with edge shape data stored in a first storage unit, and calculate a position fluctuation amount in the width direction of the endless belt. A compensator outputs a correction signal based on the position fluctuation amount. The correction signal is stored in a third storage unit. A fourth storage unit stores a transfer function. A changing unit changes the edge shape data stored in the first storage unit using the edge position, the correction signal, and the transfer function.

### BACKGROUND OF THE INVENTION

1. Field of the Invention

The present disclosure relates to a belt drive apparatus for driving an endless belt.

2. Description of the Related Art

Various image forming apparatuses employing an electrophotographic process or an electrostatic recording process as an image forming process have been developed. Such image forming apparatuses include printers, facsimile machine, and multifunction peripherals (MFPs). In the image forming apparatuses, some image forming apparatuses employ an endless belt as an intermediate transfer member for bearing a toner image to be transferred from an image bearing member, or a recording material conveyance mechanism for bearing and conveying a recording material on which a toner image is to be transferred from an image bearing member. Some other apparatuses employ an endless belt for a fixing device for heating and fixing a toner image transferred onto a recording material.

In such belt drive apparatuses employing the endless belts for the intermediate transfer members or the transfer material conveyance mechanisms, belt deviation or meandering may occur in driving the belts. The belt deviation and meandering at the time of belt drive are caused by various external forces, for example, a belt drive mechanism, mechanical precision of the belt, characteristic changes of the belt, and vibrations of a conveyance belt due to a transfer material entering from a transfer material supplying mechanism to the transfer material conveyance belt. To solve the problems, methods of detecting an edge position of a belt and correcting the belt deviation and the meandering using a steering roller for adjusting the arrangement angle with respect to the belt based on the detection result have been known.

The detection result includes, however, the edge shape components of the belt. Therefore, for example, a method of removing the edge shape components from a detection result of a belt deviation position using stored edge shape data acquired by measuring only in a belt replacement has been known. The edge shape of the endless belt changes, not only in the belt replacement, but also due to temperature and humidity changes caused by an installation environment and usage states of the apparatus, plastic deformation over time caused by long-term use, and deterioration caused by wear and tear of the belt. Consequently, appropriate correction of the meandering of the belt is difficult only by the edge shape data in the belt replacement.

Japanese Patent No. 3632731 discusses a technique for checking a difference between a current edge shape of a belt and edge shape data stored in a storage unit at a predetermined timing, and if the difference is large, interrupting the drive of the belt, and reacquiring and updating (changing) the edge shape data.

Japanese Patent No. 3931467 discusses a technique for comparing current edge shape data and edge shape data stored in a storage unit, and even if the difference is large, setting the gain of a compensator to a value less than one, and reacquiring and updating (changing) the edge shape data without interrupting the drive of the belt.

The technique discussed in Japanese Patent No. 3632731, however, interrupts the drive of the belt, and this may decrease productivity in image formation. The technique discussed in Japanese Patent No. 3931467 sets the gain of the compensator to a value less than one in reacquiring the edge shape, therefore, if a sudden disturbance causing belt position fluctuation occurs, correction control of position in a width direction of the belt may diverge.

### SUMMARY OF THE INVENTION

According to an aspect disclosed herein, a belt drive apparatus includes an endless belt, a drive unit configured to drive the endless belt to travel, an edge position detection unit configured to detect an edge position in a width direction intersecting with a traveling direction of the endless belt, a first storage unit configured to store edge shape data of the endless belt, a second storage unit configured to store the edge position detected by the edge position detection unit, a position fluctuation amount calculation unit configured to compare the edge position detected by the edge position detection unit and the edge shape data stored in the first storage unit, and to calculate a position fluctuation amount in the width direction of the endless belt, a compensator configured to output a correction signal corresponding to the position fluctuation amount calculated by the position fluctuation amount calculation unit, a belt width direction position correction unit configured to correct the position in the width direction of the endless belt according to the correction signal output from the compensator, a third storage unit configured to store the correction signal output from the compensator, a fourth storage unit configured to store a transfer function representing a relationship between an input value to the belt width direction position correction unit and the position in the width direction of the endless belt to be corrected by the belt width direction position correction unit, and a changing unit configured to change the edge shape data stored in the first storage unit using the edge position stored in the second storage unit, the correction signal stored in the third storage unit, and the transfer function stored in the fourth storage unit.

Further features of the present invention will become apparent from the following description of exemplary embodiments with reference to the attached drawings.

### BRIEF DESCRIPTION OF THE DRAWINGS

FIG. 1 is a cross-sectional view illustrating a schematic structure of an image forming apparatus having a belt drive apparatus according to the first exemplary embodiment.

FIG. 2 is a detail view illustrating near a steering roller in FIG. 1.

FIGS. 3A and 3B respectively illustrate an arrangement of a belt edge sensor and a schematic structure of the belt edge sensor.

FIG. 4 illustrates a schematic system structure of the belt drive apparatus.

FIG. 5 is a block diagram with respect to belt deviation correction control according to the first exemplary embodiment.

FIGS. 6A, 6B, 6C, and 6D illustrate examples of relationships between a position in a belt traveling direction and a belt position fluctuation amount, respectively, without edge shape correction, after removal of edge shape, at the occurrence of disturbance, and at the occurrence of an edge shape error.

FIG. 7 is a flowchart illustrating an example of the belt deviation correction control according to the first exemplary embodiment.

FIG. 8 is a block diagram with respect to belt deviation correction control according to the second exemplary embodiment of the present invention.

FIG. 9 is a flowchart illustrating an example of the belt deviation correction control according to the second exemplary embodiment.

### DESCRIPTION OF THE EMBODIMENTS

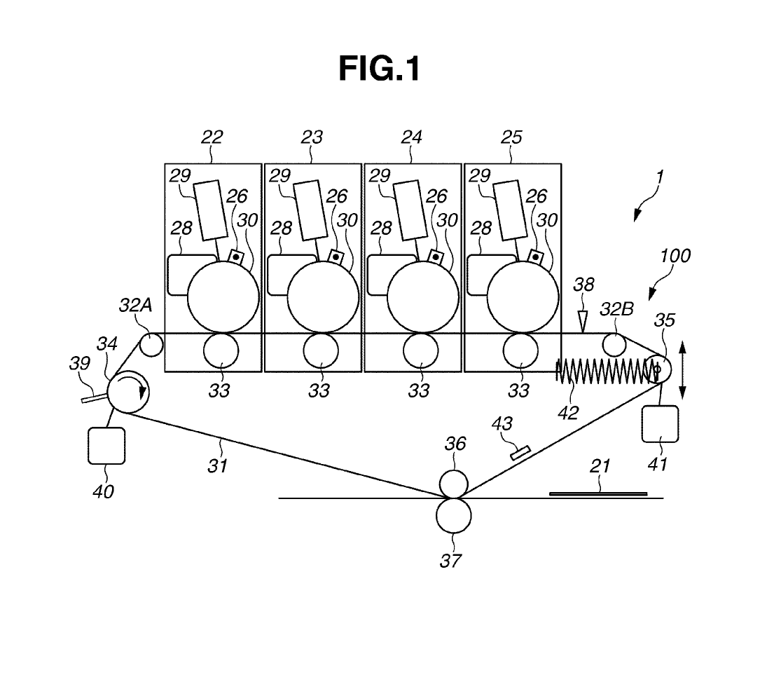

The first exemplary embodiment is described with reference to FIG. 1 to FIG. 7. First, a schematic structure of an image forming apparatus according to the exemplary embodiment is described with reference to FIG. 1.

[Image Forming Apparatus]

An image forming apparatus 1 is an electro-photographic type full-color image forming apparatus. The image forming apparatus 1 performs operation described below based on a control signal from a control unit (not illustrated). In FIG. 1, the image forming apparatus includes a Y (yellow) image forming unit 22, an M (magenta) image forming unit 23, a C (cyan) image forming unit 24, and a K (black) image forming unit 25. Since the structure of each image forming unit is similar, in the following description, the Y image forming apparatus 22 is described in detail, and descriptions of the other image forming units are omitted. In the exemplary embodiment, the four image forming units are used. However, it is not limited to the structure.

The Y image forming unit 22 includes a photosensitive drum (image bearing member) 30. On the surface of the photosensitive drum 30, a latent image is formed with light from a laser scanner (exposure device) 29. A primary charging device 26 charges the surface of the photosensitive drum 30 to a predetermined potential to prepare for latent image formation. A development unit 28 develops the latent image on the photosensitive drum 30 to form a toner image. The development unit 28 includes a sleeve (not illustrated) for applying a developing bias to develop images. A primary transfer roller 33 applies a voltage from the back of an intermediate transfer belt 31, and transfer the toner image on the photosensitive drum 30 onto the intermediate transfer belt 31. A drum cleaning blade (not illustrated) is arranged to scrape off the toner remaining on the photosensitive drum 30 after the completion of the transfer for the next image formation.

The intermediate transfer belt 31, which is an endless belt, is stretched with a belt drive roller 34, driven rollers 32A and 32B, a steering roller 35, and a secondary transfer inner roller 36, and serves as a belt drive device 100. The secondary transfer inner roller 36 further transfers the toner image transferred onto the intermediate transfer belt 31 onto a recording sheet 21, which is a recording material.

The steering roller 35 is pressed with a spring 42 from the inside to the outside of the intermediate transfer belt 31, and movably attached. This applies a constant tension to the intermediate transfer belt 31. As will be described in detail below, control of correction (deviation correction) of a position in the width direction of the intermediate transfer belt 31 is performed by changing alignment of the steering roller 35.

The belt drive roller 34 is rotated by a belt drive motor 40, which serves as a drive unit, to travel the intermediate transfer belt 31 in the direction of an arrow in the drawing. In this exemplary embodiment, the image forming apparatus 1 includes a belt home detection sensor 43 for detecting a mark provided at a position in the traveling (conveyance) direction of the intermediate transfer belt 31.

The toner image formed on the photosensitive drum 30 is primarily transferred onto the intermediate transfer belt 31, which also serves as an image bearing member, by the action of the primary transfer roller 33. Similar image formation is performed in the image forming units 23, 24, and 25 to form toner images of respective colors. The toner images are sequentially layered and transferred onto the toner images formed earlier.

Meanwhile, the recording sheet 21 is conveyed from a sheet feeding unit (not illustrated) to a secondary transfer area, and by the action of the secondary transfer inner roller 36 and a secondary transfer outer roller 37, the toner image formed on the intermediate transfer belt 31 is transferred onto the recording sheet 21. The waste toner remaining on the intermediate transfer belt 31 without being transferred is removed with a cleaning blade 39, which serves as a contact member that contacts the intermediate transfer belt 31, and the intermediate transfer belt 31 is to be used for the next image formation.

[Belt Deviation Correction Mechanism]

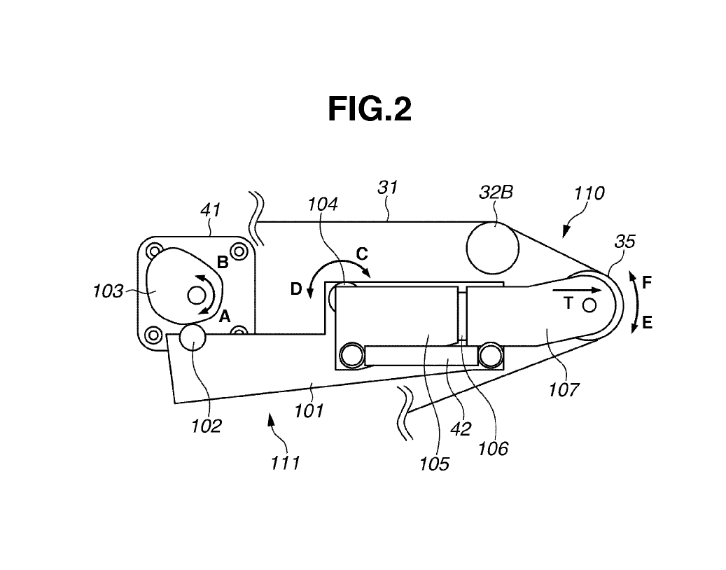

With reference to FIG. 2, a belt deviation correction mechanism 110 in the belt drive apparatus 100 is described. The belt drive apparatus 100 includes the belt deviation correction mechanism 110, which serves as a belt width direction position correction unit for performing control of correction (deviation correction) of a position in the width direction of the intermediate transfer belt 31.

The belt deviation correction mechanism 110 includes the steering roller 35 and a roller inclining mechanism 111. The steering roller 35 is rotatably supported by a bearing holder 107. The bearing holder 107 is fixed at a movable side of a slide rail 106. On the same side of the movable side of the slide rail 106, a slider 105 is also fixed. The fixing side of the slide rail 106 is fixed to a steering arm (supporting member) 101. The slider 105 is urged in an arrow T direction by a spring (urging member) 42 provided to the steering arm 101. The slider 105, therefore, slides on the steering arm 101, and as a result, the steering roller 35 is urged in the arrow T direction applying a tension to the intermediate transfer belt 31. In this exemplary embodiment, the steering roller 35 is urged by the spring 42 to apply a constant tension to the intermediate transfer belt 31. However, the steering function and the tension application function can be separately provided as different mechanisms.

The roller inclining mechanism 111 includes the steering arm 101, an inclining shaft 104, a cam 103, a follower 102, and a steering motor 41. The steering arm 101 in the front side illustrated in FIG. 2 is swingably supported with the inclining shaft 104 as a center. On the steering arm 101, the follower 102 is supported in the symmetric direction to the steering roller 35 with respect to the inclining shaft 104. The cam 103 is provided so as to contact the follower 102. The cam 103 can be rotated with the steering motor (driving unit) 41.

In this structure, rotation of the cam 103 in the arrow A direction illustrated in FIG. 2 rotates the follower 102 side of the steering arm 101 in the arrow C direction about the inclining shaft 104. As a result, the steering roller 35 side rotates in the arrow E direction to change alignment. On the other hand, rotation of the cam 103 in the arrow B direction rotates the follower 102 side of the steering arm 101 in the arrow D direction about the inclining shaft 104. As a result, the steering roller 35 side rotates in the arrow F direction to change alignment. The shift in the alignment of the steering roller 35 in the arrow E direction moves the intermediate transfer belt 31 to the inner side of FIG. 2. The shift in the alignment in the arrow F direction moves the intermediate transfer belt 31 to the front side of FIG. 2.

In this exemplary embodiment, a steering arm (not illustrated) at the inner side is fixed. Alternatively, for example, a mechanism similar to the front side may be provided at the inner side such that both mechanisms at the front side and the inner side can swing. In such a case, the steering arms 101 can swing about the central position of the steering roller 35 by setting the swing directions of the steering arms to the opposite directions each other at the front side and at the inner side, and by adjusting absolute values of amounts of swing of the both sides to the same value.

[Edge Sensor]

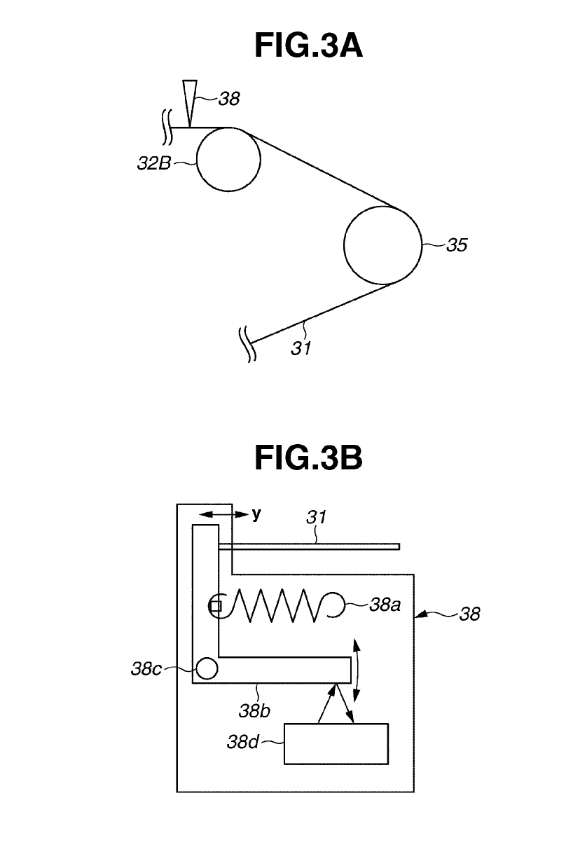

With reference to FIGS. 3A and 3B, a method of detecting an amount of belt deviation is described. In FIG. 3A, an edge sensor 38, which serves as an edge position detection unit, is arranged on a traveling downstream direction of a transfer surface of the intermediate transfer belt 31, on which a toner image is to be transferred from the photosensitive drum 30. The edge sensor 38 detects an edge position (belt deviation position) in a width direction intersecting with the traveling direction of the intermediate transfer belt 31. The transfer surface includes a driven roller 32A arranged far side from the steering roller 35 and a driven roller 32B arranged near the steering roller 35.

FIG. 3B illustrates a specific structure of the edge sensor 38. The edge sensor 38 is held in a state being pressed to contact an edge of the intermediate transfer belt 31 at one end side of a contactor 38b with a tension of a spring 38a. In this case, the pressure of the contactor 38b by the spring 38a is set to an appropriate pressure so as not to deform the intermediate transfer belt 31. The contactor 38b is rotatably supported with a supporting shaft 38c at the midpoint portion. A displacement sensor 38d is arranged in a facing state with the other end side of the contactor 38b across the supporting shaft 38c.

In the edge sensor 38, a movement of the intermediate transfer belt 31 in the width direction (the y direction in FIG. 3B) in a belt meandering state is converted into a movement (swinging operation) of the contactor 38b which is pressing and contacting the edge of the intermediate transfer belt 31. An output level of the displacement sensor 38d varies correspondingly to the movement (displacement) of the contactor 38b. Based on the sensor output, the position of the intermediate transfer belt 31 in the width direction can be continuously detected.

The sensor for detecting the position in the width direction of the belt can be the above-described contact-type sensor arranged at the belt edge. Alternatively, a non-contact sensor can be used. The mechanism of the non-contact sensor includes, for example, a method of reading a mark on a belt from above the belt with the non-contact sensor. In any mechanism, the edge sensor 38 is arranged at the belt edge directly detecting an amount of deviation of the belt deviation position.

[System Structure of Belt Drive Apparatus]

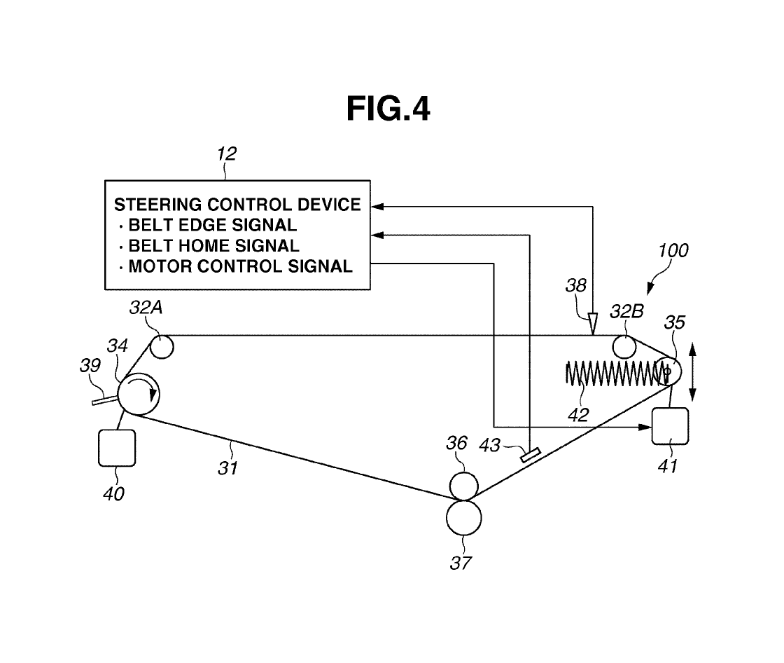

With reference to FIG. 4, a system structure of the belt drive apparatus 100 is described. In FIG. 4, a steering control device 12 outputs motor control signals to a steering motor 41 to control the drive of the steering motor 41, which serves as a drive source for a correction unit for belt deviation and meandering. For the steering motor 41, a stepping motor that can precisely control rotation angles and rotation speeds is preferably used. The steering control device 12 is connected to the above-mentioned belt home detection sensor 43 and the edge sensor 38. From the belt home detection sensor 43, a belt home signal is input, and from the edge sensor 38, a belt edge signal is input, respectively.

[Belt Deviation Correction Control]

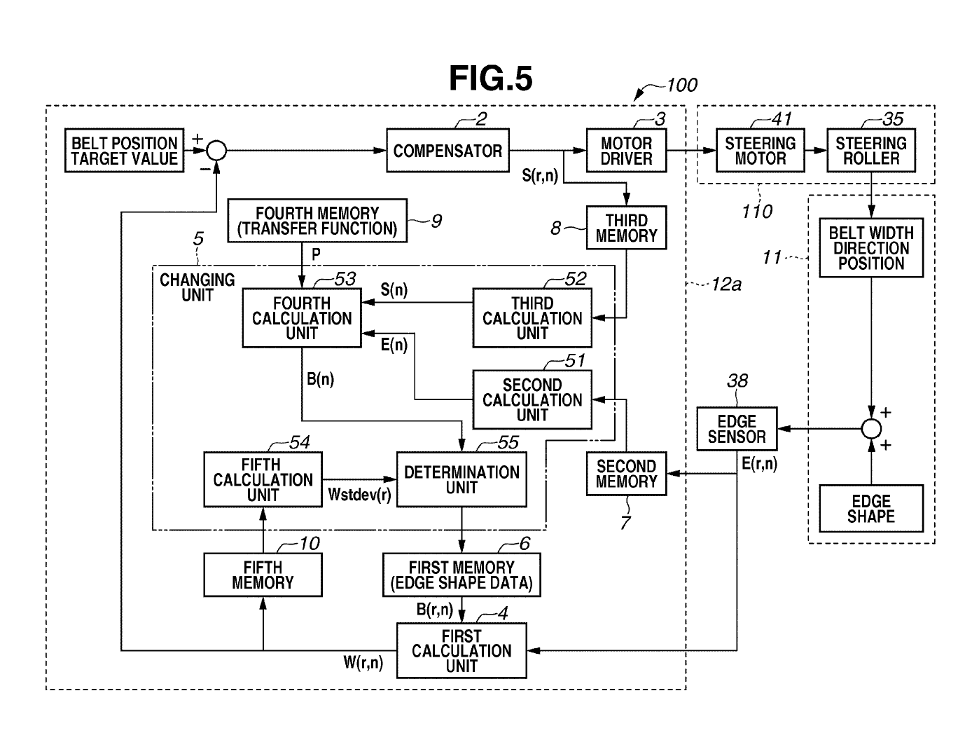

With reference to FIGS. 5 to 7, a belt deviation correction control (steering control) for correcting belt deviation and meandering according to the exemplary embodiment is described. In FIG. 5, a controller 12a, which serves as a control unit, includes a part of the above-described functions of the steering control device 12. The controller 12a includes, as main components, a compensator 2, a motor driver 3, a first calculation unit 4, a changing unit 5, and various memories 6 to 10. The various memories 6 to 10 can be one storage device, or a plurality of storage devices. The steering motor 41 and the steering roller 35 correspond to the belt deviation correction mechanism 110 in FIG. 2. A belt module 11 is a mechanism having the intermediate transfer belt 31, and rollers 32A, 32B, 34, and 36 for stretching the intermediate transfer belt 31.

The first memory 6, which serves as a first storage unit, stores edge shape data of the intermediate transfer belt 31. At the initial stage, data measured in advance before an installation into the apparatus, or data measured with the edge sensor 38 at the time of the first power supply is stored in the first memory 6. The edge shape data stored in the first memory 6 is, as will be described below, changed (updated) with the changing unit 5.

The first calculation unit 4, which serves as a position fluctuation amount calculation unit, compares an edge position detected with the edge sensor 38 with the edge shape data stored in the first memory 6, and calculates a position fluctuation amount (belt deviation position) in the width direction of the intermediate transfer belt 31. In other words, in addition to the actual positional fluctuation in the belt width direction, the edge shape of the belt is added as a read error to the edge sensor 38 for detecting a position in the belt width direction. In this exemplary embodiment, in the execution of the belt deviation correction control, edge shape data B (r, n) in the first memory 6 is subtracted from data E (r, n) in the edge sensor 38 to calculate a belt position fluctuation amount W (r, n) from which the belt edge shape is subtracted. This reduces the read error due to the edge shape of the belt. The edge position E (r, n) detected by the edge sensor 38 is stored in the second memory 7, which serves as a second storage unit.

The value “r” indicates the number of times belt home signals have been output by the belt home detection sensor 43 since the start of the rotation of the intermediate transfer belt 31, that is, the number of times the intermediate transfer belt 31 has been rotated since the start of the rotation. The value “n” indicates a corresponding address in the conveyance direction of the intermediate transfer belt 31 based on the belt home signal.

The compensator 2 outputs a correction signal corresponding to the position fluctuation amount calculated by the first calculation unit 4. That is, the compensator 2 outputs, to the motor driver 3, a correction signal S (r, n) corresponding to the deviation between the belt position fluctuation amount W (r, n) and a belt position target value. The correction signal S (r, n) is to be used as a steering motor driver instruction value. In this exemplary embodiment, for the steering motor 41, a stepping motor is used, and accordingly, the correction signal S (r, n) output from the compensator 2 corresponds to the number of motor steps. The correction signal S (r, n) output from the compensator 2 is stored in the third memory 8, which serves as a third storage unit.

The motor driver 3, according to the correction signal S (r, n) as the steering motor driver instruction value, drives the steering motor 41. The motor drive tilts the steering roller 35 to change the position in the width direction of the belt. In other words, according to the correction signal S (r, n) output from the compensator 2, the belt deviation correction mechanism 110 corrects the position in the width direction of the intermediate transfer belt 31.

The fourth memory 9, which serves as a fourth storage unit, stores a transfer function P that indicates a relationship between an input value to the belt deviation correction mechanism 110, and a position in the width direction of the intermediate transfer belt 31 to be corrected by the belt deviation correction mechanism 110. The transfer function P is a mathematical representation of the relation between the steering motor instruction value and the position fluctuation amount in the width direction of the intermediate transfer belt 31 caused by a tilt of the steering roller 35. Such a transfer function can be obtained by modeling a physical system, or obtained according to a system identification method to be performed prior to shipment. Alternatively, in a state an image forming operation is stopped, the system identification method can be performed to reacquire the transfer function, and the function can be stored in the fourth memory 9. This enables the apparatus to respond to changes in the roller alignment due to the installation environment of the apparatus, and changes in the transfer function due to changes in the coefficient of friction between the roller and the belt. The timing and method for obtaining the transfer function are not limited to the above-mentioned timing and methods.

The changing unit 5, which serves as a changing unit, changes the edge shape data B (r, n) stored in the first memory 6. The change is performed using the edge position E (r, n) stored in the second memory 7, the correction signal S (r, n) stored in the third memory 8, and the transfer function stored in the fourth memory 9. Specifically, the changing unit 5 obtains new edge shape data by subtracting, from the data relating to the edge position stored in the second memory 7, a value obtained by multiplying the data relating to the correction signal stored in the third memory 8 by the transfer function P stored in the fourth memory 9.

The data relating to the edge position is, for example, an average E (n) of the edge positions of the intermediate transfer belt 31 of a predetermined number of rotations stored in the second memory 7. The data relating to the correction signal is an average S (n) of the correction signals of a predetermined number of rotations of the intermediate transfer belt 31 stored in the third memory 8. Each of the data is not limited to the above-mentioned data, and alternatively, for example, last data (data of one cycle of the belt immediately before a change) stored before a change can be used. In this exemplary embodiment, each of the data is a value obtained by averaging data of a predetermined number of rotations of the intermediate transfer belt 31. The changing unit 5, therefore, includes a second calculation unit 51 for calculating the average E (n) of the edge positions, and a third calculation unit 52 for calculating the average S (n) of the correction signals. The changing unit 5 also includes a fourth calculation unit 53 for performing calculation of the edge shape data.

The changing unit 5 is described more specifically. The changing unit 5 reads the data of the edge position E (r, n) and the correction signal (motor instruction value) S (r, n), for example, for three rotations of the belt, from the second memory 7 and the third memory 8, respectively. Then, the second calculation unit 51 divides the sum of the edge positions E (1, n), E (2, n), and E (3, n) at the same address in each rotation by three, which is the number of rotations of the belt, to calculate the data E (n) relating to the edge position. The third calculation unit 52 divides the sum of the correction signal S (1, n), S (2, n), and S (3, n) at the same address in each rotation by three, which is the number of rotations of the belt, to calculate the data S (n) relating to the correction signal. Further, on the S (n) and E (n), each calculation unit respectively performs tilt correction of data and offset correction of data such that each of the average value is to be zero. That is, the data is corrected to the data that can be compared with each other. Then, the fourth calculation unit 53 subtracts, from the data E (n) relating to the edge position, a value obtained by multiplying the data S (n) relating to the correction signal and the transfer function in the fourth memory 9. An obtained value is to be used as new edge shape data B (n).

A fifth memory 10, which serves as a fifth storage unit, stores the position fluctuation amount W (r, n) calculated with the first calculation unit 4. The changing unit 5, in a case where the value relating to the position fluctuation amount stored in the fifth memory 10 during one rotation of the intermediate transfer belt 31 is within a predetermined range, changes the edge shape data. That is, in a case where the standard deviation of the W (r, n), which is a difference between the edge shape data B (r, n) and the data E (r, n) of the edge sensor 38, is within a range described below, the changing unit 5 changes the edge shape data B (r, n) in the first memory 6. For this operation, the changing unit 5 includes a fifth calculation unit 54 and a determination unit 55.

The fifth calculation unit 54 calculates a belt position fluctuation standard deviation (standard deviation of W (r, n)) Wstdev (r) at r rotations of the intermediate transfer belt 31, as the value relating to the data of the position fluctuation amount stored in the fifth memory 10, using the following equation (1).

$$Wstdev ( r ) = \sqrt{\frac{\text{?} {( W ( r , n ) - \overline{W ( r , n )} )}^{2}}{( N - 1 )}} \\ \text{?} \text{indicates text missing or illegible when filed} \qquad ( 1 )$$

( W̅(̅r̅,̅n̅)̅) : average value of W (r, n) at address N at r rotations.

The determination unit 55 compares the belt position fluctuation standard deviation Wstdev (r) calculated by the equation (1) with preset values Wₜₕ_{_{—}}ₘᵢₙ and Wₜₕ_{_{—}}ₘₐₓ. Then, the determination unit 55 determines whether the belt position fluctuation standard deviation Wstdev (r) is greater than Wₜₕ_{_{—}}ₘᵢₙ and equal to or less than Wₜₕ_{_{—}}ₘₐₓ (within the predetermined range). If the belt position fluctuation standard deviation Wstdev (r) is within the predetermined range, the error between the edge shape data in the first memory 6 and the current belt edge shape is large. Consequently, the edge shape data in the first memory 6 is to be changed (updated) to the edge shape data B (n) calculated in the fourth calculation unit 53.

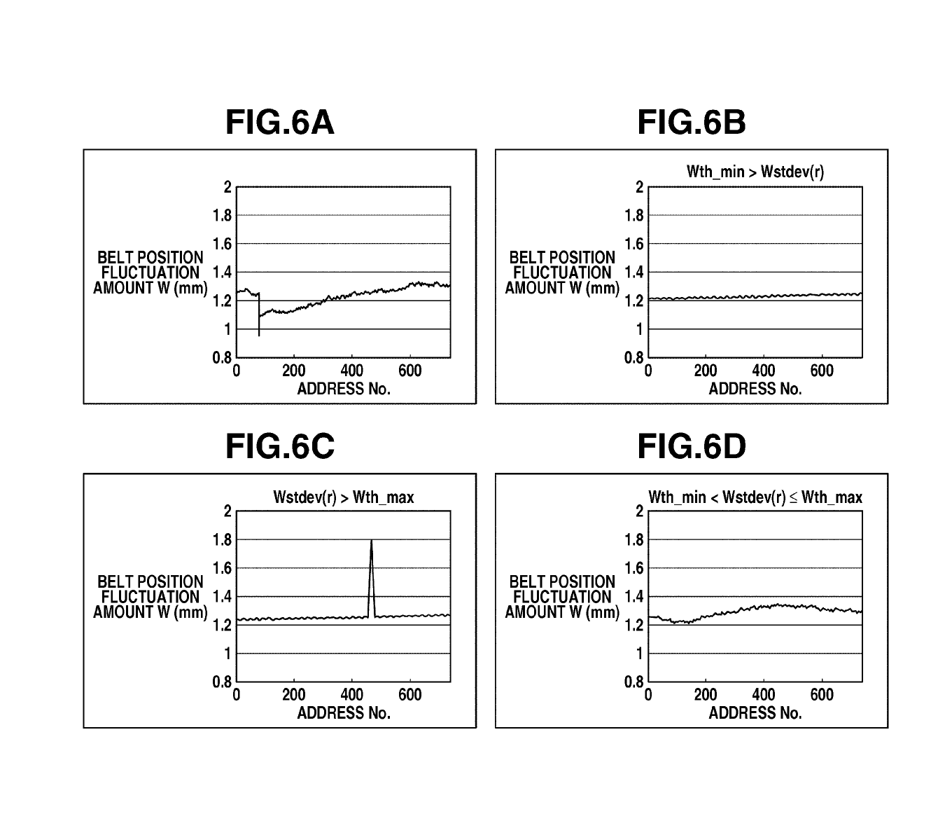

FIGS. 6A, 6B, 6C, and 6D illustrate an example of data of the belt position fluctuation amount W (r, n) in the determination in the determination unit 55. FIG. 6A illustrates a belt position fluctuation amount W (r, n), which is obtained without subtracting the edge shape data B (r, n) in the first memory 6 from the detection value E (r, n) detected by the edge sensor 38.

FIG. 6B illustrates data, which is obtained by subtracting the edge shape data B (r, n) in the first memory 6 from the detection value E (r, n) detected by the edge sensor 38 to remove the edge shape , that is, indicating an actual position in the belt width direction. In this state, the belt position fluctuation standard deviation Wstdev (r) at r rotations is below the Wₜₕ_{_{—}}ₘᵢₙ.

FIG. 6C illustrates a belt position fluctuation amount W (r, n) in a state a sudden disturbance occurred. In this state, the above-described belt position fluctuation standard deviation Wstdev (r) at r rotations exceeds the Wₜₕ_{_{—}}ₘₐₓ.

FIG. 6D illustrates a state there is an error between the edge shape data in the first memory 6 and the current belt edge shape. In such a state, the above-described belt position fluctuation standard deviation Wstdev (r) at r rotations has a relationship of Wₜₕ_{_{—}}ₘᵢₙ<Wstdev (r)≦Wₜₕ_{_{—}}ₘₐₓ. In this state, the determination unit 55 updates the edge shape data. In this exemplary embodiment, for a criterion in updating the edge shape data, the standard deviation is used. Alternatively, variance can be used for the criterion, and the criterion is not limited to the above-described value.

[Control Flow]

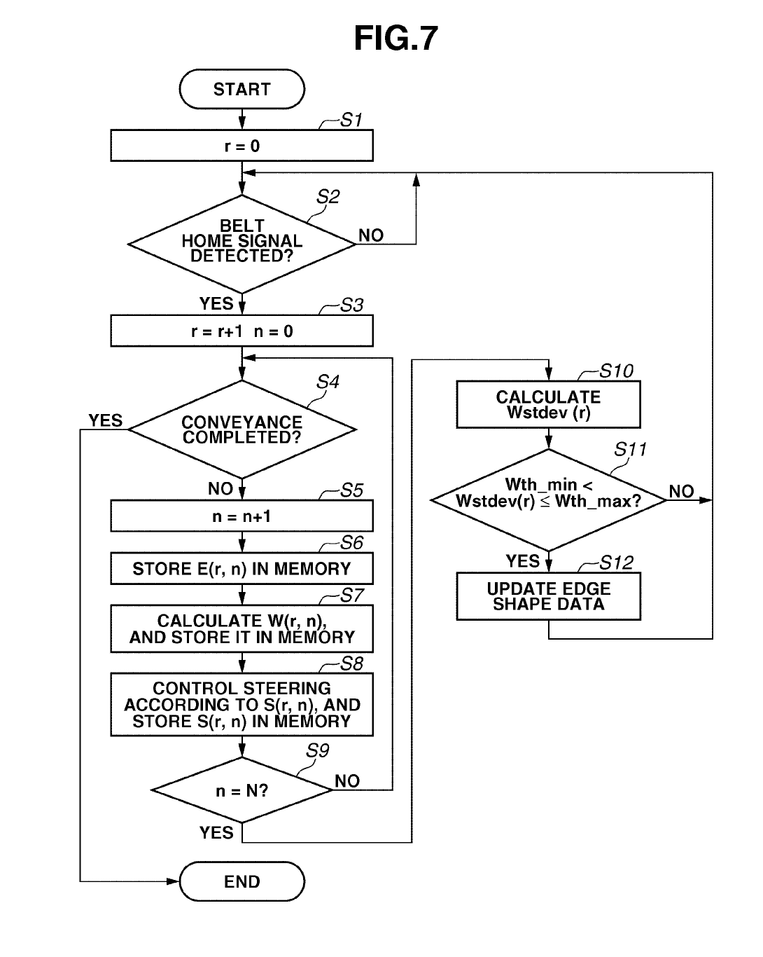

With reference to the flowchart in FIG. 7, the belt deviation correction control to be performed during image formation operation and the procedure of updating the edge shape data will be described. In step S1, in response to a start of conveyance of the intermediate transfer belt 31 by the rotation of the belt drive roller 34, the controller 12a resets the number of rotations r of the belt to zero. In step S2, the controller 12a repeatedly determines whether the belt home signal has been output from the belt home detection sensor 43. If the controller 12a detects the belt home signal (YES in step S2), in step S3, the controller 12a increments (+1) the number of rotations r of the belt, and resets the value n of the corresponding address in the belt rotation direction (traveling direction).

In step S4, the controller 12a determines whether a signal indicating completion of the conveyance of the intermediate transfer belt 31 has been input. If the signal has been input (YES in step S4), the processing ends. If the signal has not been input (NO in step S4), in step S5, the controller 12a increments (+1) the value n of the corresponding address in the belt rotation direction.

In step S6, the controller 12a acquires the detection data E (r, n) of the edge sensor 38 based on the output timing of the belt home signal, and stores the data E (r, n) in the second memory 7. In step S7, the controller 12a calculates a difference between the detection data E (r, n) in the edge sensor 38 and the corresponding edge shape data B (r, n) stored in the first memory 6, calculates a belt position fluctuation amount W (r, n), and stores the amount W (r, n) in the fifth memory 10.

In step S8, the controller 12a performs steering control according to the correction signal S (r, n) output from the compensator 2 based on the deviation of the belt position fluctuation amount W (r, n) relative to the belt position target value. By the control, the steering motor 41 is driven by the motor driver 3, and the steering roller 35 tilts. Then, the controller 12a stores the correction signal S (r, n) in the third memory 8 based on the output timing of the belt home signal.

In step S9, the controller 12a determines whether the value “n” of the address has reached the number of pieces of data N to be detected in one rotation. If the value “n” has not reached the number of pieces of the data N (NO in step S9), the process returns to step S4. If the value “n” has reached the number of pieces of the data N (YES in step S9), in step S10, the fifth calculation unit 54 calculates the belt position fluctuation standard deviation Wstdev (r) at r rotations.

In step 511, the controller 12a determines whether the belt position fluctuation standard deviation Wstdev (r) is within the range of Wₜₕ_{_{—}}ₘᵢₙ<Wstdev (r)≦Wₜₕ_{_{—}}ₘₐₓ. If the Wstdev (r) is outside the range (NO in step S11), the process returns to step S2. In step S11, if the Wstdev (r) is within the range (YES in step S11), the controller 12a determines that the error between the edge shape data in the first memory 6 and the current belt edge shape has increased, and the process proceeds to step S12. In step S12, the controller 12a updates the edge shape data in the first memory 6. That is, as described above, the fourth calculation unit 53 subtracts the value obtained by multiplying the data S (n) relating to the correction signal and the transfer function in the fourth memory 9 from the data E (n) relating to the edge position to obtain the new edge shape data B (n). The controller 12a changes the edge shape data in the first memory 6 to the new edge shape data B (n).

As described above, in this exemplary embodiment, the edge shape data is changed using the edge position, the correction signal, and the transfer function. Consequently, without stopping the drive of the belt, even if a sudden disturbance occurs by not setting the gain of the compensator 2 to a value less than 1, the edge shape data can be changed without divergence of the position correction control in the width direction of the intermediate transfer belt 31. As a result, color misregistration due to edge shape error components can be reduced, and high-quality print products can be obtained.

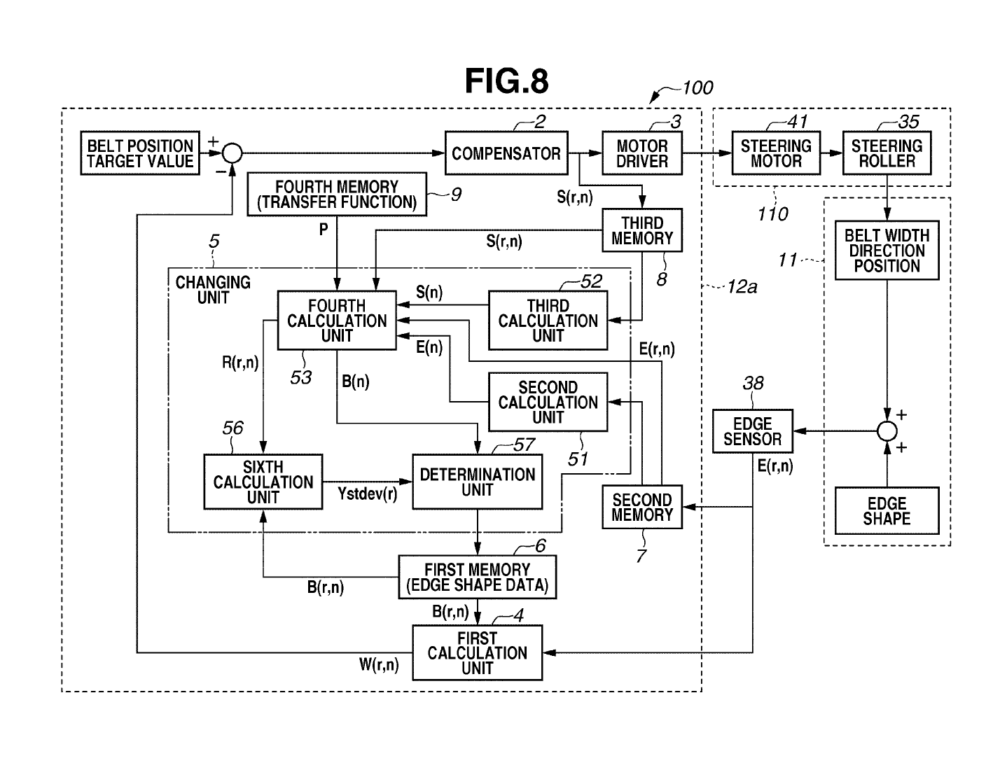

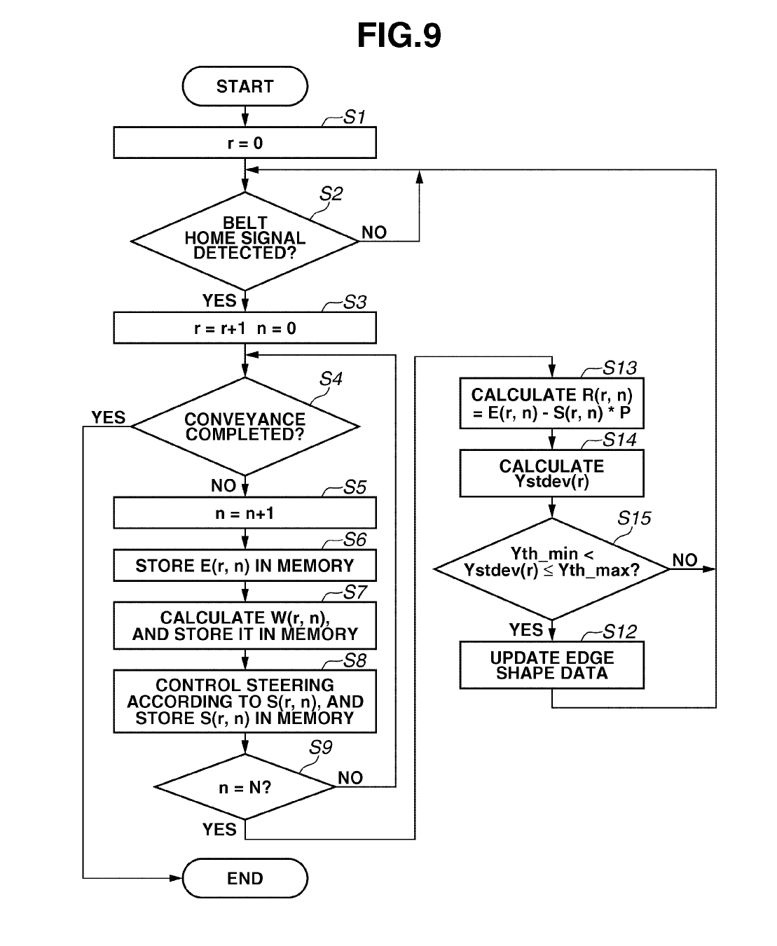

The second exemplary embodiment according to the present invention is described with reference to FIG. 8 and FIG. 9. In this exemplary embodiment, the determination criterion for determining whether to update the edge shape data is different from that in the first exemplary embodiment. To configurations similar to those in the first exemplary embodiment, the same reference numerals are applied, and their descriptions are omitted or simply described. Hereinafter, points different from those in the first exemplary embodiment will be mainly described.

In this exemplary embodiment, the changing unit 5 includes a sixth calculation unit 56 and a determination unit 57. The fourth calculation unit 53 calculates data R (r, n) from the data stored in the second memory 7 and the third memory 8 during one rotation of the intermediate transfer belt 31 (for example, see FIG. 1) and the transfer function P stored in the fourth memory 9. That is, the changing unit 5 subtracts a value obtained by multiplying the data S (r, n) of the correction signal stored in the third memory 8 by the transfer function P from the data E (r, n) of the edge position stored in the second memory to calculate the data R (r, n).

The sixth calculation unit 56 calculates a value Ystdev (r) relating to a difference between the data R (r, n) and the edge shape data B (r, n) stored in the first memory 6. The determination unit 57 determines whether the value Ystdev (r) is within a predetermined range. If the value Ystdev (r) is within the predetermined range, the edge shape data stored in the first memory 6 is changed.

With reference to the flowchart in FIG. 9, the processing is specifically described. The processing in step S1 to S9 in FIG. 9 is similar to that in the flowchart in FIG. 7 described in the first exemplary embodiment, therefore, the processing from step S13 is described in detail.

In step S13, the fourth calculation unit 53 subtracts a value obtained by multiplying the correction signal S (r, n) and the transfer function P from the data E (r, n) in the edge sensor 38. An obtained value is defined as R (r, n). The sixth calculation unit 56 calculates a difference between the obtained value R (r, n) and the edge shape data B (r, n) stored in the first memory 6 to calculate Y (r, n). Then, in step S14, the sixth calculation unit 56 calculates a standard deviation Ystdev (r) of the edge shape correction differences at r rotations using the following equation (2).

$$Wstdev ( r ) = \sqrt{\frac{\text{?} {( W ( r , n ) - \overline{W ( r , n )} )}^{2}}{( N - 1 )}} \\ \text{?} \text{indicates text missing or illegible when filed} \qquad ( 2 )$$

( Y̅(̅r̅,̅n̅)̅) : value of Y (r, n) at address N in r rotations.

The determination unit 57 compares the standard deviation Ystdev (r) of the edge shape correction differences calculated by the equation (2) with preset values Yₜₕ_{_{—}}ₘᵢₙ and Yₜₕ_{_{—}}ₘₐₓ. Then, in step S15, the determination unit 57 determines whether the belt position fluctuation standard deviation Ystdev (r) is greater than Yₜₕ_{_{—}}ₘᵢₙ and equal to or less than Yₜₕ_{_{—}}ₘₐₓ (within the predetermined range). If the belt position fluctuation standard deviation Ystdev (r) is outside the range (NO in step S15), the process returns to step S2. In step S15, if the Ystdev (r) is within the range (YES in step S15), the determination unit 57 determines that the error between the edge shape data in the first memory 6 and the current belt edge shape has increased, and the process proceeds to step S12. In step S 12, the determination unit 57 updates the edge shape data in the first memory 6. The edge shape data updating method is similar to that in the first exemplary embodiment, therefore, its description is omitted. In this exemplary embodiment the standard deviation is used for a criterion in updating the edge shape data. Alternatively, variance can be used for the criterion, and the criterion is not limited to the above-described value. The other configurations and action are similar to those in the above-described first exemplary embodiment.

In the above-described exemplary embodiments, the mechanism of driving the intermediate transfer belt in the image forming apparatus is described. Alternatively, the present invention can be applied to other mechanisms having a belt. For example, a mechanism using an endless belt for a recording material conveyance mechanism for carrying and conveying a recording material for transferring a toner image from an image bearing member, or a mechanism using an endless belt in a fixing device for heating and fixing a toner image transferred on a recording material can be used.

According to the exemplary embodiments of the present invention, the edge shape data is changed using the edge position, the correction signal, and the transfer function. Consequently, without stopping the drive of the belt, even if a sudden disturbance occurs, the edge shape data can be changed without divergence of the position correction control in the width direction of the endless belt.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-256793 filed Nov. 22, 2012, which is hereby incorporated by reference herein in its entirety.

What is claimed is:

1. A belt drive apparatus comprising:
an endless belt;
a drive unit configured to drive the endless belt to travel;
an edge position detection unit configured to detect an edge position in a width direction intersecting with a traveling direction of the endless belt;
a first storage unit configured to store edge shape data of the endless belt;
a second storage unit configured to store the edge position detected by the edge position detection unit;
a position fluctuation amount calculation unit configured to compare the edge position detected by the edge position detection unit and the edge shape data stored in the first storage unit, and to calculate a position fluctuation amount in the width direction of the endless belt;
a compensator configured to output a correction signal corresponding to the position fluctuation amount calculated by the position fluctuation amount calculation unit;
a belt width direction position correction unit configured to correct the position in the width direction of the endless belt according to the correction signal output from the compensator;
a third storage unit configured to store the correction signal output from the compensator;
a fourth storage unit configured to store a transfer function representing a relationship between an input value to the belt width direction position correction unit and the position in the width direction of the endless belt to be corrected by the belt width direction position correction unit; and
a changing unit configured to change the edge shape data stored in the first storage unit using the edge position stored in the second storage unit, the correction signal stored in the third storage unit, and the transfer function stored in the fourth storage unit.

2. The belt drive apparatus according to claim 1,
wherein the changing unit obtains new edge shape data by subtracting a value obtained by multiplying the data relating to the correction signal stored in the third storage unit by the transfer function stored in the fourth storage unit from the data relating to the edge position stored in the second storage unit.

3. The belt drive apparatus according to claim 2,
wherein the data relating to the edge position is an average of the edge positions of a predetermined number of rotations of the endless belt stored in the second storage unit, and
wherein the data relating to the correction signal is an average of the correction signals of the predetermined number of rotations stored in the third storage unit.

4. The belt drive apparatus according to claim 3, further comprising:
a fifth storage unit configured to store the position fluctuation amount calculated by the position fluctuation amount calculation unit,
wherein the changing unit changes the edge shape data, in a case where the value relating to the position fluctuation amount stored in the fifth storage unit during one rotation of the endless belt is within a predetermined range.

5. The belt drive apparatus according to claim 3,
wherein the changing unit changes the edge shape data in a case where a value relating to a difference between data, which is obtained by subtracting a value obtained by multiplying the data of the correction signal stored in the third storage unit during one rotation by the transfer function stored in the fourth storage unit from the data of the edge position stored in the second storage unit during one rotation of the endless belt , and the edge shape data, which is stored in the first storage unit, is within a predetermined range.
